(19) United States
(12) Patent Application Publication
(10) Pub. No.: US 2023/0006201 A1
(43) Pub. Date: Jan. 5, 2023

(54) OVER-LITHIATED CATHODE MATERIALS AND METHODS OF FORMING THE SAME

(71) Applicant: GM GLOBAL TECHNOLOGY OPERATIONS LLC, Detroit, MI (US)

(72) Inventors: Lei WANG, Rochester Hills, MI (US); Jiazhi HU, Troy, MI (US)

(73) Assignee: GM GLOBAL TECHNOLOGY OPERATIONS LLC, Detroit, MI (US)

(21) Appl. No.: 17/363,985

(22) Filed: Jun. 30, 2021

(51) Int. Cl. H01M 4/505; H01M 4/36; H01M 4/04; H01M 10/0525

(52) U.S. Cl. CPC H01M 4/505; H01M 4/364; H01M 4/0447; H01M 10/0525; H01M 2004/028

(57) ABSTRACT

Over-lithiated cathode materials for use in an electrochemical cell that cycles lithium ions, and methods of making and using the same, are provided. The over-lithiated cathode materials may include positive electroactive materials selected from the group consisting of: Li₂Mn₂O₄, Li₂MSiO₄ (where M is Fe, Mn, Co, or Mn), Li₂VOPO₄, and combinations thereof. Methods for preparing the positive electroactive material may include charging an electrochemical cell at a first voltage window and discharging the electrochemical cell at a second a second voltage window that is less than the first voltage window. The electrochemical cell may include a positive electrode, including the positive electroactive material, and a negative electrode, including a volume-expanding negative electroactive material. During charging, lithium ions and electrons may move from the positive electrode to the negative electrode. During discharging, a portion of the lithium ions and electrons may remain at the negative electrode as a lithium reservoir.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand. More specifically, electrical power can be supplied to a load device by the lithium-ion battery until the lithium content of the negative electrode is effectively depleted. The battery may then be recharged by passing a suitable direct electrical current in the opposite direction between the electrodes.

During discharge, the negative electrode may contain a comparatively high concentration of intercalated lithium, which is oxidized into lithium ions releasing electrons. Lithium ions may travel from the negative electrode to the positive electrode, for example, through the ionically conductive electrolyte solution contained within the pores of an interposed porous separator. Concurrently, electrons pass through an external circuit from the negative electrode to the positive electrode. Such lithium ions may be assimilated into the material of the positive electrode by an electrochemical reduction reaction. The battery may be recharged or regenerated after a partial or full discharge of its available capacity by an external power source, which reverses the electrochemical reactions that transpired during discharge.

In various instances, however, a portion of the intercalated lithium remains with the negative electrode following the first cycle due to, for example, conversion reactions and/or the formation of a solid electrolyte interphase (SEI) layer on the negative electrode during the first cycle, as well as ongoing lithium loss due to, for example, continuous solid electrolyte interphase breakage. Such permanent loss of lithium ions may result in a decreased specific energy and power in the battery resulting from, for example, added positive electrode mass that does not participate in the reversible operation of the battery. For example, the lithium-ion battery may experience an irreversible capacity loss of greater than or equal to about 5% to less than or equal to about 30% after the first cycle, and in the instance of silicon-containing negative electrodes, or other volume-expanding negative electroactive materials (e.g., tin (Sn), aluminum (Al), germanium (Ge)), an irreversible capacity loss of greater than or equal to about 20% to less than or equal to about 40% after the first cycle.

Current methods to compensate for first cycle lithium loss include, for example, electrochemical processes where a silicon-containing anode is lithiated using an electrolyte bath. However, such processes are susceptible to electrolyte pollution, and as a result, instability. Another method of compensation includes, for example, in-cell lithiation, which includes adding lithium to a cell. Such processes, however, require the use of mesh current collectors, which have high material costs, as well as coating costs. Yet another method of compensation includes, for example, the deposition of lithium on an anode. However, in such instances, it is difficult (and costly) to produce evenly deposited lithium layers. Accordingly, it would be desirable to develop improved electrodes and electroactive materials, and methods of making and using the same, that can address these challenges.

### SUMMARY

This section provides a general summary of the disclosure, and is not a comprehensive disclosure of its full scope or all of its features.

The present disclosure relates to over-lithiated cathode materials (i.e., positive electroactive materials) for use in an electrochemical cell that cycles lithium ions, and methods of making and using the same.

In various aspects, the positive electrode includes a positive electroactive material. The positive electroactive material may be selected from the group consisting of: Li₂Mn₂O₄, Li₂MSiO₄ (where M is Fe, Mn, Co, or Mn), Li₂VOPO₄, and combinations thereof.

In one aspect, the positive electroactive material may be a first positive electroactive material, and the positive electrode may further include a second positive electroactive material.

In one aspect, the first positive electroactive material may have a first lithiation/dilithiation voltage window, and the second positive electroactive material may have a second lithiation/dilithiation voltage window that is less than the first lithiation/dilithiation voltage window.

In one aspect, the first lithiation/dilithiation voltage window may be greater than or equal to about 1.5 V to less than or equal to about 4.6 V.

In one aspect, the second lithiation/dilithiation voltage window may be greater than or equal to about 2.5 V to less than or equal to about 4.3 V.

In one aspect, the second positive electroactive material may be selected from the group consisting of: LiMn₂O₄, LiNiMnCo (NMC), Li₂Mn₂O₄, Li₂MSiO₄ (where M is Fe, Mn, Co, or Mn), Li₂VOPO₄, Li(NiₓMn_{y}Co_{z}Alₚ)O₂, where 0≤x≤1, 0≤y≤1, 0≤z≤1, 0≤P≤1, x+y+z+p=1 (NCMA), lithium iron phosphate (LiFePO₄) (LFP), lithium manganese iron phosphate (LMFP), lithium manganese nickel oxide (LiMn_{1.5}Ni_{0.5}O₄) (LMNO), lithium cobalt oxide (LiCoO₂) (LCO), lithium nickel cobalt aluminum oxide (LiNi_{0.8}Co_{0.15}Al_{0.05}O₂) (NCA), and combinations thereof.

In one aspect, an amount of the first positive electroactive material (X₁) in the positive electrode may be determined using formula (I):

X₁=(C_{PL}/Q₁)/(C_{PL}/Q₁+(Cₚ−C_{PL})/Q₂)×100% (I)

and, an amount of the second positive electroactive material (X₂) in the positive electrode is determined using formula (II)

X₂=100%−X₁ (II)

where Cₚ is the total charge capacity of the cathode, C_{PL} is the target pre-lithiation amount, Q₁ is the specific lithium capacity of the first positive electroactive material, and Q₂ is the specific lithium capacity of the second electroactive material.

In one aspect, the positive electrode may include greater than or equal to about 1 wt. % to less than or equal to about 99 wt. % of the first positive electroactive material, and greater than or equal to about 1 wt. % to less than or equal to about 99 wt. % of the second positive electroactive material.

In various aspects, the present disclosure provides an electrochemical cell that cycles lithium ions. The electrochemical cell may include a positive electrode. The positive electrode may include a positive electroactive material. The positive electroactive material may be selected from the group consisting of: Li₂Mn₂O₄, Li₂MSiO₄ (where M is Fe, Mn, Co, or Mn), Li₂VOPO₄, and combinations thereof. After the first lithiation/dilithiation cycle, the electrochemical cell may have an operational voltage window of greater than or equal to about 2.7 V to less than or equal to about 4.5 V.

In one aspect, the positive electroactive material may be a first positive electroactive material and the positive electrode may further include a second positive electroactive material.

In one aspect, the first positive electroactive material may have a first lithiation/dilithiation voltage window, and the second positive electroactive material may have a second lithiation/dilithiation voltage window that is less than the first lithiation/dilithiation voltage window.

In one aspect, the first lithiation/dilithiation voltage window may be greater than or equal to about 1.5 V to less than or equal to about 4.6 V.

In one aspect, the second lithiation/dilithiation voltage window is greater than or equal to about 2.5 V to less than or equal to about 4.3 V.

In one aspect, the second positive electroactive material may be selected from the group consisting of: LiMn₂O₄, LiNiMnCo (NMC), Li₂Mn₂O₄, Li₂MSiO₄ (where M is Fe, Mn, Co, or Mn), Li₂VOPO₄, Li(NiₓMn_{y}Co_{z}Alₚ)O₂, where 0≤x≤1, 0≤y≤1, 0≤z≤1, 0≤P≤1, x+y+z+p=1 (NCMA), lithium iron phosphate (LiFePO₄) (LFP), lithium manganese iron phosphate (LMFP), lithium manganese nickel oxide (LiMn_{1.5}Ni_{0.5}O₄) (LMNO), lithium cobalt oxide (LiCoO₂) (LCO), lithium nickel cobalt aluminum oxide (LiNi_{0.8}Co_{0.15}Al_{0.05}O₂) (NCA), and combinations thereof.

In one aspect, an amount of the first positive electroactive material (X₁) in the positive electrode may be determined using formula (I):

X₁=(C_{PL}/Q₁)/(C_{PL}/Q₁+(Cₚ−C_{PL})/Q₂)×100% (I)

and, an amount of the second positive electroactive material (X₂) in the positive electrode is determined using formula (II)

X₂=100%−X₁ (II)

where Cₚ is the total charge capacity of the cathode, C_{PL} is the target pre-lithiation amount, Q₁ is the specific lithium capacity of the first or over-lithiated positive electroactive material, and Q₂ is the specific lithium capacity of the second or another positive electroactive material.

In one aspect, the positive electrode may include greater than or equal to about 1 wt. % to less than or equal to about 99 wt. % of the first positive electroactive material, and greater than or equal to about 1 wt. % to less than or equal to about 99 wt. % of the second positive electroactive material.

In one aspect, the electrochemical cell may further include a negative electrode. The negative electrode may include a volume-expanding negative electroactive material.

In various aspects, the present disclosure may provide a method for preparing a lithium reservoir in an electrochemical cell that cycles lithium ions. The method may include charging the electrochemical cell at a first voltage window and discharging the electrochemical cell at a second a second voltage window that is less than the first voltage window. The electrochemical cell may include a positive electrode and a negative electrode. The positive electrode may include a positive electroactive material selected from the group consisting of: Li₂Mn₂O₄, Li₂MSiO₄ (where M is Fe, Mn, Co, or Mn), Li₂VOPO₄, and combinations thereof. During charging, lithium ions (Li⁺) and electrons (e⁻) may move from the positive electrode to the negative electrode. During discharging, a portion of the lithium ions (Li⁺) and electrons (e⁻) may remain at the negative electrode as a lithium reservoir.

In one aspect, the first voltage window may be greater than or equal to about 1.5 V to less than or equal to about 4.6 V.

In one aspect, the second voltage window may be greater than or equal to about 2.5 V to less than or equal to about 4.3 V.

In one aspect, after the first cycle of the charging and the discharging, the electrochemical cell may have the electrochemical cell has an operational voltage window greater than or equal to about 2.7 V to less than or equal to about 4.5 V.

In one aspect, the positive electroactive material may be a first positive electroactive material, and the positive electrode may further include a second positive electroactive material.

In one aspect, the first positive electroactive material may have a first lithiation/dilithiation voltage window, and the second positive electroactive material may have a second lithiation/dilithiation voltage window that is less than the first lithiation/dilithiation voltage window.

In one aspect, the first lithiation/dilithiation voltage window may be greater than or equal to about 1.5 V to less than or equal to about 4.6 V.

In one aspect, the second lithiation/dilithiation voltage window may be greater than or equal to about 2.5 V to less than or equal to about 4.3 V.

In one aspect, the method may further include determining an amount of the first positive electroactive material and an amount of the second positive electroactive material to be included in the positive electrode.

In one aspect, the amount of the first positive electroactive material (X₁) in the positive electrode may be determined using formula (I):

X₁=(C_{PL}/Q₁)/(C_{PL}/Q₁+(Cₚ−C_{PL})/Q₂)×100% (I)

and, the amount of the second positive electroactive material (X₂) in the positive electrode is determined using formula (II)

X₂=100%−X₁ (II)

where Cₚ is the total charge capacity of the cathode, C_{PL} is the target pre-lithiation amount, Q₁ is the specific lithium capacity of the first or over-lithiated positive electroactive material, and Q₂ is the specific lithium capacity of the second or another positive electroactive material.

In one aspect, the positive electrode may include greater than or equal to about 1 wt. % to less than or equal to about 99 wt. % of the first positive electroactive material, and greater than or equal to about 1 wt. % to less than or equal to about 99 wt. % of the second positive electroactive material.

In one aspect, the negative electrode may include a volume-expanding negative electroactive material.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell; and

FIG. 2 is a graphical illustration demonstrating areal discharge capacity and discharge capacity retention of example battery cells prepared in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

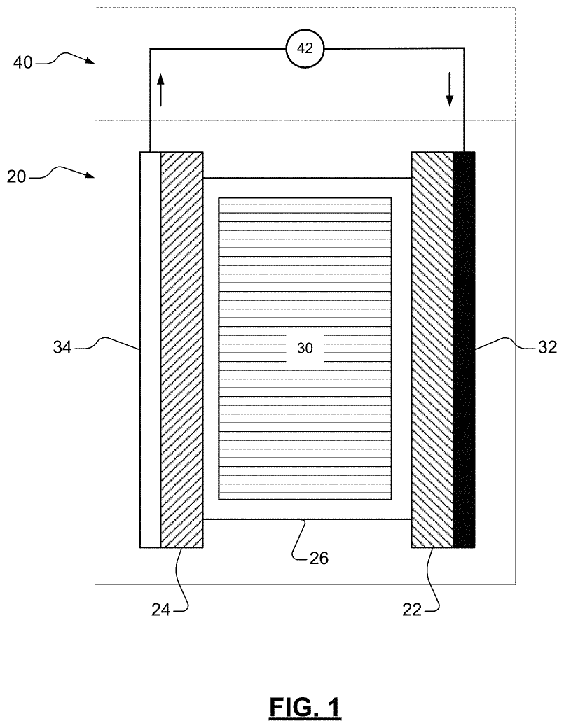

A typical lithium-ion battery includes a first electrode (such as a positive electrode or cathode) opposing a second electrode (such as a negative electrode or anode) and a separator and/or electrolyte disposed therebetween. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions (or sodium ions in the case of sodium-ion batteries, and the like) and may be in liquid, gel, or solid form. For example, an exemplary and schematic illustration of an electrochemical cell (also referred to as the battery) 20 is shown in FIG. 1.

Such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single positive electrode cathode and a single anode, the skilled artisan will recognize that the present teachings extend to various other configurations, including those having one or more cathodes and one or more anodes, as well as various current collectors with electroactive layers disposed on or adjacent to one or more surfaces thereof.

The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte. For example, the separator 26 may be defined by a plurality of solid-state electrolyte particles (not shown).

A negative electrode current collector 32 may be positioned at or near the negative electrode 22. The negative electrode current collector 32 may be a metal foil, metal grid or screen, or expanded metal comprising copper or any other appropriate electrically conductive material known to those of skill in the art. A positive electrode current collector 34 may be positioned at or near the positive electrode 24. The positive electrode current collector 34 may be a metal foil, metal grid or screen, or expanded metal comprising aluminum or any other appropriate electrically conductive material known to those of skill in the art. The negative electrode current collector 32 and the positive electrode current collector 34 respectively collect and move free electrons to and from an external circuit 40. For example, an interruptible external circuit 40 and a load device 42 may connect the negative electrode 22 (through the negative electrode current collector 32) and the positive electrode 24 (through the positive electrode current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the negative electrode current collector 32, negative electrode 22, separator 26, positive electrode 24, and positive electrode current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries that include solid-state electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution (e.g., >1M) that includes a lithium salt dissolved in an organic solvent or a mixture of organic solvents. Numerous conventional non-aqueous liquid electrolyte 30 solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic materials and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have a thickness greater than or equal to about 1 μm to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 in FIG. 1 may be replaced with a solid-state electrolyte (“SSE”) layer (not shown) that functions as both an electrolyte and a separator. The solid-state electrolyte layer may be disposed between the positive electrode 24 and negative electrode 22. The solid-state electrolyte layer facilitates transfer of lithium ions, while mechanically separating and providing electrical insulation between the negative and positive electrodes 22, 24. By way of non-limiting example, the solid-state electrolyte layer may include a plurality of solid-state electrolyte particles such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂Si₂, Li₂S—P₂S₅, Li₆PS₅Cl, Li₆PS₅Br, Li₆PS₅I, Li₃OCl, Li_{2.99} Ba_{0.005}ClO, or combinations thereof. The solid-state electrolyte particles may be nanometer sized oxide-based solid-state electrolyte particles. In still other variations, the porous separator 26 and/or the electrolyte 30 in FIG. 1 may be replaced with a gel electrolyte.

The negative electrode 22 may be formed from a lithium host material (or a sodium-based active material in the instance of sodium-ion batteries) that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. For example, in certain variations, the negative electrode 22 may include a plurality of solid-state electrolyte particles (not shown). The negative electrode 22 (including the one or more layers) may have a thickness greater than or equal to about 1 μm to less than or equal to about 500 μm, and in certain aspects, optionally greater than or equal to about 10 μm to less than or equal to about 200 μm.

The negative electrode 22 may include a negative electroactive material that comprises lithium, such as, for example, lithium metal. In certain variations, the negative electrode may be a film or layer formed of lithium metal. Other materials can also be used to form the negative electrode 22, including, for example, carbonaceous materials (such as, graphite, hard carbon, soft carbon), and/or lithium-silicon, silicon containing binary and ternary alloys, and/or tin-containing alloys (such as, Si, Li—Si, SiOₓ (where 0≤x≤2), Si—Sn, SiSnFe, SiSnAl, SiFeCo, SnO₂, and the like), and/or other volume-expanding materials (e.g., aluminum (Al), germanium (Ge)). For example, in certain variations, the negative electroactive material may include a carbonaceous-silicon based composite including, for example, about 10 wt. % SiOₓ (where 0≤x≤2) and about 90 wt. % graphite.

In certain variations, the negative electroactive material(s) in the negative electrode 22 may be optionally intermingled with one or more electrically conductive materials that provide an electron conductive path and/or at least one polymeric binder material that improves the structural integrity of the negative electrode 22. For example, the negative electroactive material(s) in the negative electrode 22 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like. In certain aspects, mixtures of the conductive materials may be used.

In various aspects, the negative electrode 22 may include greater than or equal to about 10 wt. % to less than or equal to about 99 wt. %, and in certain variations, greater than or equal to about 50 wt. % to less than or equal to about 95 wt. %, of the negative electroactive material(s); greater than or equal to about 0 wt. % to less than or equal to 40 wt. %, and in certain aspects, optionally greater than or equal to about 1 wt. % to less than or equal to about 20 wt. %, of the electronically conducting material; and greater than or equal to about 0 wt. % to less than or equal to about 40 wt. %, and in certain aspects, optionally greater than or equal to about 1 wt. % to less than or equal to about 20 wt. %, of the at least one polymeric binder.

The positive electrode 24 may be formed from a lithium-based active material (or a sodium-based active material in the instance of sodium-ion batteries) that is capable of undergoing lithium intercalation and deintercalation, alloying and dealloying, or plating and stripping, while functioning as the positive terminal of the battery 20. The positive electrode 24 can be defined by a plurality of electroactive material particles (not shown). Such positive electroactive material particles may be disposed in one or more layers so as to define the three-dimensional structure of the positive electrode 24. The electrolyte 30 may be introduced, for example after cell assembly, and contained within pores (not shown) of the positive electrode 24. For example, in certain variations, the positive electrode 24 may include a plurality of solid-state electrolyte particles (not shown). The positive electrode 24 may have a thickness greater than or equal to about 1 μm to less than or equal to about 500 μm, and in certain aspects, optionally greater than or equal to about 10 μm to less than or equal to about 200 μm.

As discussed above, during discharge, the negative electrode 22 may contain a comparatively high concentration of intercalated lithium, which is oxidized into lithium ions and electrons. Lithium ions may travel from the negative electrode 22 to the positive electrode 24, for example, through the ionically conductive electrolyte 30 contained within the pores of an interposed porous separator 26. Concurrently, electrons pass through an external circuit 40 from the negative electrode 22 to the positive electrode 24. Such lithium ions may be assimilated into the material of the positive electrode 22 by an electrochemical reduction reaction. The battery 20 may be recharged or regenerated after a partial or full discharge of its available capacity by an external power source, which reverses the electrochemical reactions that transpired during discharge.

In certain instances, however, especially in instances of silicon-containing electroactive materials, a portion of the intercalated lithium remains with the negative electrode 22 for example, conversion reactions and/or the formation of LiₓSi and/or a solid electrolyte interphase (SEI) layer (not shown) on the negative electrode 22 during the first cycle, as well as ongoing lithium loss due to, for example, continuous solid electrolyte interphase (SEI) breakage and rebuild. The solid electrolyte interface (SEI) layer can form over the surface of the negative electrode (anode), which is often generated by reaction products of anode material, electrolyte reduction, and/or lithium ion reduction. Such permanent loss of lithium ions may result in a decreased specific energy and power in the battery 20. For example, the battery 20 may experience an irreversible capacity loss of greater than or equal to about 5% to less than or equal to about 30% after the first cycle.

Lithiation, for example pre-lithiation of the electroactive materials prior to incorporation into the battery 20, may compensate for such lithium losses during cycling. For example, an amount of lithium prelithiated together with appropriate negative electrode capacity and/or positive electrode capacity ratio (N/P ratio) can be used to control electrochemical potential within an appropriate window so as to improve the cycle stability of the battery 20. Prelithiation can drive down the potential for silicon-containing electrodes. By way of non-limiting example, lithiation of silicon by direct reaction can be expressed by: 4.4xLi+Si→Li_{4.4x}Si, where 0≤x≤1, while for electrochemical lithiation of silicon, it can be expressed as 4.4xLi⁺+4.4xe⁻⁺Si→Li_{4.4x}Si. In each instance, the reserved lithium can compensate for lithium lost during cycling, including during the first cycle, so as to decrease capacity loss over time.

Common lithiation methods, such as electrochemical, direct contact, and lamination methods; however, often require half-cell fabrication and teardown and/or high temperature chemical processes. Furthermore, it can be difficult to control an extent of lithiation that occurs during these processes. Further, these processes often involve highly reactive chemicals and require additional manufacturing steps. These may be time consuming and potentially expensive processes. Further, such processes also commonly produce unworkable materials, for example anodes having undesirable thicknesses. The present disclosure provides over-lithiated cathode materials, and methods of forming the same, which can help to address these challenges.

For example, in various aspects, the positive electrode 24 includes an over-lithiated positive electroactive material that provides, or serves as, a lithium reservoir in the cell 20. For example, the positive electrode 24 may include one or more over-lithiated positive electroactive materials, such as Li₂Mn₂O₄, Li₂MSiO₄ (where M is Fe, Mn, Co, or Mn), Li₂VOPO₄, or any combination thereof. During a first lithiation and dilithiation cycle of the battery 20, the over-lithiated positive electroactive material(s) releases lithium. For example, when the positive electrode 24 includes Li₂Mn₂O₄ and the positive electrode 24 is charged—for example, to about 4.2 V—during a first cell cycle, the Li₂Mn₂O₄ becomes LiMn₂O₄+Li⁺+e⁻ and the LiMn₂O₄ becomes Mn₂O₄+Li⁺+e⁻, such that a total charge capacity, a first value (e.g., about 8.4 mAh/cm²), is release from the positive electrode 24. That is, the charging profile in such instances can be depicted as:

Li₂Mn₂O₄→LiMn₂O₄+Li⁺+e⁻

LiMn₂O₄→Mn₂O₄+Li⁺+e⁻

To complete the first cell cycle, the cell is subsequently discharged—for example, to about 3.2 V—and the Mn₂O₄ is combined with Li⁺+e⁻ to become LiMn₂O₄, such that the discharge capacity is a second value (e.g., about 4.9 mAh/cm²) that is less than the first value. That is, the discharging profile can be depicted as:

Mn₂O₄+Li⁺+e⁻→LiMn₂O₄

A portion of the capacity—for example, the difference between the first value and the second value (e.g., about 3.5 mAh/cm²)—remains with the negative electrode 22 as a lithium reservoir.

In certain variations, the positive electrode 24 may include a blended positive electroactive material. For example, the over-lithiated positive electroactive material may be a first positive electroactive material, and the positive electrode 24 may further include a second positive electroactive material.

The first or over-lithiated positive electroactive material has a first lithiation/dilithiation voltage window, and the second or another positive electroactive material has a second lithiation/dilithiation voltage window. For example, the first lithiation/dilithiation window may be greater than or equal to about 1.5 V to less than or equal to about 4.6 V, and in certain aspects, optionally greater than or equal to about 2 V to less than or equal to about 4.2 V. The second lithiation/dilithiation window may be greater than or equal to about 2.5 V to less than or equal to about 4.3 V, and in certain aspects, optionally greater than or equal to about 3 V to less than or equal to about 4.2 V.

In certain variations, the second positive electroactive material may be selected from the group consisting of: LiMn₂O₄, LiNiMnCo (NMC), Li₂Mn₂O₄, Li₂MSiO₄ (where M is Fe, Mn, Co, or Mn), Li₂VOPO₄, Li(NiₓMn_{y}Co_{z}Alₚ)O₂, where 0≤x≤1, 0≤y≤1, 0≤z≤1, 0≤P≤1, x+y+z+p=1 (NCMA), lithium iron phosphate (LiFePO₄) (LFP), lithium manganese iron phosphate (LMFP) (e.g., LiMnFePO₄ and/or LiMnₓFe₁₋ₓPO₄, where 0≤x≤1), lithium manganese nickel oxide (LiMn_{1.5}Ni_{0.5}O₄) (LMNO), lithium cobalt oxide (LiCoO₂) (LCO), lithium nickel cobalt aluminum oxide (LiNi_{0.8}Co_{0.15}Al_{0.05}O₂) (NCA), and combinations thereof.

A desirable amount of the amount (X_{NMC} or X₂) of the second or another positive electroactive material in the positive electrode 24 may be determined using the Formulas (I) and (II):

X_{LMO}=(C_{PL}/Q_{LMO})/(C_{PL}/Q_{LMO}+(Cₚ−C_{PL})/Q_{NMC})×100% (I)

X_{NMC}=100%−X_{LMO} (II)

where Cₚ is the total charge capacity of the cathode, C_{PL} is the target pre-lithiation amount, Q_{LMO} or Q₁ is the specific lithium capacity of the first or over-lithiated positive electroactive material, and Q_{NMC} or Q₂ is the specific lithium capacity of the second or another positive electroactive material.

In certain variations, the positive electrode 24 may include greater than or equal to about 1 wt. % to less than or equal to about 99 wt. %, and in certain aspects, optionally, greater than or equal to about 20 wt. % to less than or equal to about 80 wt. %, of the first or over-lithiated positive electroactive material, and greater than or equal to about 1 wt. % to less than or equal to about 99 wt. %, and in certain aspects, optionally, greater than or equal to about 20 wt. % to less than or equal to about 80 wt. %, of the second or another positive electroactive material.

With renewed reference to FIG. 1, in certain variations, the positive electroactive material(s) in the positive electrode 24 may be optionally intermingled with an electronically conducting material that provides an electron conduction path and/or at least one polymeric binder material that improves the structural integrity of the electrode 24. For example, the positive electroactive material(s) in the positive electrode 24 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETJEN™ black or DENKA™ black), carbon fibers and nanotubes, graphene, and the like. Examples of a conductive polymer include polyaniline, polythiophene, polyacetylene, polypyrrole, and the like. In certain aspects, mixtures of the conductive materials may be used.

In various aspects, the positive electrode 24 may include greater than or equal to about 10 wt. % to less than or equal to about 99 wt. %, and in certain variations, greater than or equal to about 50 wt. % to less than or equal to about 98 wt. %, of the positive electroactive material(s); greater than or equal to about 0 wt. % to less than or equal to about 40 wt. %, and in certain aspects, optionally greater than or equal to about 1 wt. % to less than or equal to about 20 wt. %, of the electronically conducting material; and greater than or equal to about 0 wt. % to less than or equal to about 40 wt. %, and in certain aspects, optionally greater than or equal to about 1 wt. % to less than or equal to about 20 wt. %, of the at least one polymeric binder.

In various aspects, the present disclosure provides methods of making the over-lithiated positive electroactive material for using in positive electrodes, such as the positive electrode 24 illustrated in FIG. 1. For example, in certain variations, the over-lithiated positive electroactive material may be prepared using a solid-state reaction and/or a wet chemical synthesis process.

The solid-state reaction process may include contacting one or more precursor materials (e.g., lithium precursors and manganese precursors) and a solvent. The one or more precursor materials and the solvent may be contacted using a ball mixing process or a mixer, as would be recognized by one having ordinary skill in the art. The one or more precursor materials may be contact simultaneously or consecutively with the solvent. In certain variations, the solvent may include one or more additives. After the one or more precursor materials and solvents are contacted, the solid-state reaction process may include heating the mixture to form the desirable phase.

The wet chemical synthesis processes include sol-gel methods, co-precipitation methods, hydrothermal methods, and the like, as would be recognized by one having ordinary skill in the art. In various aspects, the sol-gel method includes preparing a mixture of one or more precursor materials (e.g., lithium precursors and manganese precursors) and a solvent. Preparing the mixture may include heating the one or more precursor material and/or solvent to a predetermined temperature such that the mixture forms a gel-like system containing both a liquid phase and a solid phase. In certain variations, the sol-gel method may include further heating or drying the mixture to remove the liquid phase and/or to calcine the material to form the desirable structure.

In various aspects, the present disclosure provides methods of creating a lithium reservoir in an electrochemical cell that cycles lithium ions, such as the battery 20 illustrated in FIG. 1. For example, the method my include incorporating a positive electroactive material into a positive electrode. As detailed above, the positive electroactive material includes an over-lithiated or first positive electroactive material, and in certain variations, may further include a second or another positive electroactive material. In certain variations, the positive electroactive material and other cathode materials (e.g., electrolyte, binder, and/or electronically conducting material) may be slurry casted onto one or more surfaces of a positive electrode current collector (for example, like the positive electrode current collector 34 illustrated in FIG. 1).

The method may further include assembling the battery. For example, the positive electrode including the positive electroactive material may be substantially aligned with a negative electrode (for example, like the negative electrode 22 illustrated in FIG. 1). As discussed above, the negative electrode may include a silicon-containing negative electroactive material. In certain variations, prior to assembling the battery, the method may include slurry casting a negative electroactive material and other anode materials (e.g., electrolyte, binder, and/or electronically conducting material) onto one or more surfaces of a negative electrode current collector (for example, like the negative electrode current collector 32 illustrated in FIG. 1). In various aspects, the battery may have a negative electrode capacity for lithium to positive electrode capacity for lithium (N/P) ratio of greater than or equal to about 1 to less than or equal to about 5.

Further still, the method may include cycling the assembled battery. For example, the method may include charging the battery to within a first voltage window and then discharging the battery to a second voltage window, where the second voltage window is less than the first voltage window. For example, the first voltage window may be greater than or equal to about 1.5 V to less than or equal to about 4.6 V, and in certain aspects, optionally about 4.2 V. The second voltage window may be greater than or equal to about 2.5 V to less than or equal to about 4.3 V, optionally about 3.2V, and in certain aspects, optionally about 3.0 V. In performing such voltage changes, a portion of the capacity remains with the negative electrode as a lithium reservoir.

For example, when the positive electrode includes Li₂Mn₂O₄ and the positive electrode is charged—for example, to about 4.2 V—during a first cell cycle, the Li₂Mn₂O₄ becomes LiMn₂O₄+Li⁺+e⁻ and the LiMn₂O₄ becomes Mn₂O₄+Li⁺+e⁻, such that a total charge capacity, a first value (e.g., about 8.4 mAh/cm²) i That is, the charging profile in such instances can be depicted as:

Li₂Mn₂O₄→LiMn₂O₄+Li⁺+e⁻

LiMn₂O₄→Mn₂O₄+Li⁺+e⁻

To complete the first cell cycle, the cell is subsequently discharged—for example, to about 3.2 V—and the Mn₂O₄ is combined with Li⁺+e⁻ to become LiMn₂O₄, such that the discharge capacity is a second value (e.g., about 4.9 mAh/cm²) that is less than the first value. That is, the discharging profile can be depicted as:

Mn₂O₄+Li⁺+e⁻→LiMn₂O₄

A portion of the capacity—for example, the difference between the first value and the second value (e.g., about 3.5 mAh/cm²)—remains with the negative electrode as the lithium reservoir.

The battery including the lithium reservoir may be subsequently cycled. An operational voltage window of the battery may be greater than or equal to about 2.5 V to less than or equal to about 4.5 V, and in certain aspects, optionally greater than or equal to about 3.0 V to less than or equal to about 4.2V.

Certain features of the current technology are further illustrated in the following non-limiting example.

### Example

A first example cell 320 can be prepared in accordance with various aspects of the present disclosure. The first example cell 320 can include an over-lithiated cathode material and a silicon-containing anode material. For example, the over-lithiated cathode material may include Li₂Mn₂O₄.

A second example cell 330 can be prepared in accordance with various aspects of the present disclosure. The second example cell 330 can include an over-lithiated cathode material and a silicon-containing anode material. For example, the over-lithiated cathode material may include Li₂Mn₂O₄. The second example cell 330 may be the same as the first example cell 320.

A comparative cell 340 can also be prepared. The comparative cell can include a non-over-lithiated cathode material and a silicon-containing anode material. For example, the non-over-lithiated cathode material may include LiMn₂O₄.

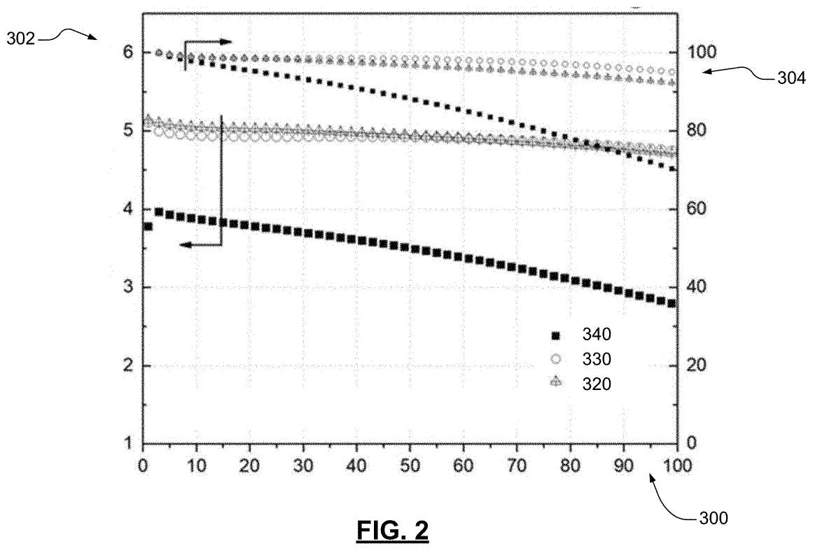

As illustrated in FIG. 2, is a graphical illustration demonstrating areal discharge capacity if the example cell and the comparative cell, where the x-axis is cycle number 300, the y₁-axis 302 is areal discharge capacity (mAh·cm⁻²), and the y₂-axis 302 is the discharge capacity retention (%). As illustrated, the example cell has improved long-term performance.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A positive electrode comprising:
a positive electroactive material, wherein the positive electroactive material is selected from the group consisting of: Li₂Mn₂O₄, Li₂MSiO₄ (where M is Fe, Mn, Co, or Mn), Li₂VOPO₄, and combinations thereof.

2. The positive electrode of claim 1, wherein the positive electroactive material is a first positive electroactive material and the positive electrode further comprises a second positive electroactive material,
wherein the first positive electroactive material has a first lithiation/dilithiation voltage window and the second positive electroactive material has a second lithiation/dilithiation voltage window that is less than the first lithiation/dilithiation voltage window.

3. The electrochemical cell of claim 2, wherein the first lithiation/dilithiation voltage window is greater than or equal to about 1.5 V to less than or equal to about 4.6 V and the second lithiation/dilithiation voltage window is greater than or equal to about 2.5 V to less than or equal to about 4.3 V.

4. The electrochemical cell of claim 2, wherein the second positive electroactive material is selected from the group consisting of: LiMn₂O₄, LiNiMnCo (NMC), Li₂Mn₂O₄, Li₂MSiO₄ (where M is Fe, Mn, Co, or Mn), Li₂VOPO₄, Li(NiₓMn_{y}Co_{z}Alₚ)O₂, where 0≤x≤1, 0≤y≤1, 0≤z≤1, 0≤P≤1, x+y+z+p=1 (NCMA), lithium iron phosphate (LiFePO₄) (LFP), lithium manganese iron phosphate (LMFP), lithium manganese nickel oxide (LiMn_{1.5}Ni_{0.5}O₄) (LMNO), lithium cobalt oxide (LiCoO₂) (LCO), lithium nickel cobalt aluminum oxide (LiNi_{0.8}Co_{0.15}Al_{0.05}O₂) (NCA), and combinations thereof.

5. The electrochemical cell of claim 2, wherein an amount of the first positive electroactive material (X₁) in the positive electrode is determined using formula (I):
X₁=(C_{PL}/Q₁)/(C_{PL}/Q₁+(Cₚ−C_{PL})/Q₂)×100% (I)
and, an amount of the second positive electroactive material (X₂) in the positive electrode is determined using formula (II)
X₂=100%−X₁ (II)
wherein Cₚ is the total charge capacity of the cathode, C_{PL} is the target pre-lithiation amount, Q₁ is the specific lithium capacity of the first positive electroactive material, and Q₂ is the specific lithium capacity of the second electroactive material.

6. The electrochemical cell of claim 2, wherein the positive electrode comprises greater than or equal to about 1 wt. % to less than or equal to about 99 wt. % of the first positive electroactive material, and greater than or equal to about 1 wt. % to less than or equal to about 99 wt. % of the second positive electroactive material.

7. An electrochemical cell that cycles lithium ions, wherein the electrochemical cell comprises:
a positive electrode comprising a positive electroactive material, wherein the positive electroactive material is selected from the group consisting of: Li₂Mn₂O₄, Li₂MSiO₄ (where M is Fe, Mn, Co, or Mn), Li₂VOPO₄, and combinations thereof, wherein, after the first lithiation/dilithiation cycle, the electrochemical cell has an operational voltage window of greater than or equal to about 2.7 V to less than or equal to about 4.5 V.

8. The electrochemical cell of claim 7, wherein the positive electroactive material is a first positive electroactive material and the positive electrode further comprises a second positive electroactive material,
wherein the first positive electroactive material has a first lithiation/dilithiation voltage window and the second positive electroactive material has a second lithiation/dilithiation voltage window that is less than the first lithiation/dilithiation voltage window.

9. The electrochemical cell of claim 8, wherein the first lithiation/dilithiation voltage window is greater than or equal to about 1.5 V to less than or equal to about 4.6 V and the second lithiation/dilithiation voltage window is greater than or equal to about 2.5 V to less than or equal to about 4.3 V.

10. The electrochemical cell of claim 8, wherein the second positive electroactive material is selected from the group consisting of: LiMn₂O₄, LiNiMnCo (NMC), Li₂Mn₂O₄, Li₂MSiO₄ (where M is Fe, Mn, Co, or Mn), Li₂VOPO₄, Li(NiₓMn_{y}Co_{z}Alₚ)O₂, where 0≤x≤1, 0≤y≤1, 0≤z≤1, 0≤P≤1, x+y+z+p=1 (NCMA), lithium iron phosphate (LiFePO₄) (LFP), lithium manganese iron phosphate (LMFP), lithium manganese nickel oxide (LiMn_{1.5}Ni_{0.5}O₄) (LMNO), lithium cobalt oxide (LiCoO₂) (LCO), lithium nickel cobalt aluminum oxide (LiNi_{0.8}Co_{0.15}Al_{0.05}O₂) (NCA), and combinations thereof.

11. The electrochemical cell of claim 8, wherein an amount of the first positive electroactive material (X₁) in the positive electrode is determined using formula (I):
X₁=(C_{PL}/Q₁)/(C_{PL}/Q₁+(Cₚ−C_{PL})/Q₂)×100% (I)
and, an amount of the second positive electroactive material (X₂) in the positive electrode is determined using formula (II)
X₂=100%−X₁ (II)
wherein Cₚ is the total charge capacity of the cathode, C_{PL} is the target pre-lithiation amount, Q₁ is the specific lithium capacity of the first or over-lithiated positive electroactive material, and Q₂ is the specific lithium capacity of the second or another positive electroactive material.

12. The electrochemical cell of claim 8, wherein the positive electrode comprises greater than or equal to about 1 wt. % to less than or equal to about 99 wt. % of the first positive electroactive material, and greater than or equal to about 1 wt. % to less than or equal to about 99 wt. % of the second positive electroactive material.

13. The electrochemical cell of claim 7, wherein the electrochemical cell further comprises:
a negative electrode comprising a volume-expanding negative electroactive material.

14. A method for preparing a lithium reservoir in an electrochemical cell that cycles lithium ions, the method comprising:
charging the electrochemical cell at a first voltage window, wherein the electrochemical cell comprises a positive electrode and a negative electrode, the positive electrode comprises a positive electroactive material selected from the group consisting of: Li₂Mn₂O₄, Li₂MSiO₄ (where M is Fe, Mn, Co, or Mn), Li₂VOPO₄, and combinations thereof, and during charging lithium ions (Li⁺) and electrons (e⁻) move from the positive electrode to the negative electrode; and
discharging the electrochemical cell at a second a second voltage window that is less than the first voltage window, such that a portion of the lithium ions (Li⁺) and electrons (e⁻) remain at the negative electrode as a lithium reservoir.

15. The method of claim 14, wherein the first voltage window is greater than or equal to about 1.5 V to less than or equal to about 4.6 V, and the second voltage window is greater than or equal to about 2.5 V to less than or equal to about 4.3 V, and
wherein, after the first cycle of the charging and the discharging, the electrochemical cell has the electrochemical cell has an operational voltage window greater than or equal to about 2.7 V to less than or equal to about 4.5 V.

16. The method of claim 14, wherein the positive electroactive material is a first positive electroactive material and the positive electrode further comprises a second positive electroactive material, wherein the first positive electroactive material has a first lithiation/dilithiation voltage window and the second positive electroactive material has a second lithiation/dilithiation voltage window that is less than the first lithiation/dilithiation voltage window.

17. The method of claim 16, wherein the first lithiation/dilithiation voltage window is greater than or equal to about 1.5 V to less than or equal to about 4.6 V and the second lithiation/dilithiation voltage window is greater than or equal to about 2.5 V to less than or equal to about 4.3 V.

18. The method of claim 16, wherein the method further comprises determining an amount of the first positive electroactive material and an amount of the second positive electroactive material to be included in the positive electrode,
wherein the amount of the first positive electroactive material (X₁) in the positive electrode is determined using formula (I):
X₁=(C_{PL}/Q₁)/(C_{PL}/Q₁+(Cₚ−C_{PL})/Q₂)×100% (I)
and, the amount of the second positive electroactive material (X₂) in the positive electrode is determined using formula (II)
X₂=100%−X₁ (II)
wherein Cₚ is the total charge capacity of the cathode, C_{PL} is the target pre-lithiation amount, Q₁ is the specific lithium capacity of the first or over-lithiated positive electroactive material, and Q₂ is the specific lithium capacity of the second or another positive electroactive material.

19. The method of claim 16, wherein the positive electrode comprises greater than or equal to about 1 wt. % to less than or equal to about 99 wt. % of the first positive electroactive material, and greater than or equal to about 1 wt. % to less than or equal to about 99 wt. % of the second positive electroactive material.

20. The method of claim 14, wherein the negative electrode comprising a volume-expanding negative electroactive material.
